(19) United States
(12) Patent Application Publication
(10) Pub. No.: US 2019/0008181 A1
(43) Pub. Date: Jan. 10, 2019

(54) DEVICE AND SYSTEM FOR DISPENSING A FROZEN CONFECTION

(71) Applicant: Conopco, Inc., d/b/a UNILEVER, Englewood Cliffs, NJ (US)

(72) Inventors: Paul SCOTT, Histon (GB); Andrew Julian STOCKDALE, Haslingfield (GB)

(21) Appl. No.: 16/067,826

(22) PCT Filed: Dec. 9, 2016
(86) PCT No.: PCT/EP2016/080427

§ 371 Date: Jul. 3, 2018

(30) Foreign Application Priority Data
Jan. 8, 2016 (EP) 16150661.3

(51) Int. Cl. A23G 9/28; A23G 9/22; A23G 9/08

(52) U.S. Cl. CPC A23G 9/281; A23G 9/08; A23G 9/228

(57) ABSTRACT

Disclosed is a device (1) for dispensing a frozen confection (13) from a receptacle (8) having a longest dimension (L). The receptacle comprises: a first compartment (20) containing the frozen confection and having a product outlet (22); and a second compartment (21) comprising a compressed gas inlet (9) and separated from the first compartment by an at least partially moveable wall (14). The device comprises: a seat (50) for locating the receptacle (8) with the longest dimension (L) aligned in a substantially horizontal direction; and a housing (2) surrounding the receptacle when located in the seat and comprising a lid (3) above the seat and allowing loading of the receptacle onto the seat.

### FIELD OF THE INVENTION

The present invention relates to devices, methods and systems for dispensing frozen confections. In particular, the invention relates to such methods, systems and devices that dispense frozen confections from receptacles through application of compressed gas.

### BACKGROUND OF THE INVENTION

In recent years, systems for dispensing frozen confections such as soft ice cream have been developed in which pre-packaged ice cream is delivered from a container by a dispensing device. In particular systems which employ bag-in-bottle type containers have been developed.

WO 2013/124193 A discloses a method for dispensing a frozen confection comprising: providing a refrigerated, insulated chamber, which houses at least one container, containing a frozen confection at a temperature of −12° C. or below; wherein the at least one container has an outlet which is closed by a self-closing valve; wherein the container comprises a flexible bag containing the frozen confection located inside a bottle; pressurising gas in the region inside the bottle and outside the flexible bag thereby applying pressure to the frozen confection so that the valve opens and the frozen confection is forced out of the container through the outlet; releasing the pressure so that the valve closes.

Such systems and devices are often designed for use in retail establishments where a large device may be desirable in order to attract the attention of passing consumers and/or to accommodate a large number of portions of frozen confections.

The present inventors have now recognized that there is a need for improvements in systems for dispensing frozen confections like soft ice using pressurized gas. In particular the present inventors have found that improving the way in which a receptacle is located in a device can allow for devices suitable for counter-top use in a domestic in-home setting without compromising functionality.

### SUMMARY OF THE INVENTION

In a first aspect, the present invention is directed to a device for dispensing a frozen confection from a receptacle having a longest dimension (L) and comprising:
a first compartment containing the frozen confection and having a product outlet; and
a second compartment comprising a compressed gas inlet and separated from the first compartment by an at least partially moveable wall;

wherein the device comprises:
a seat for locating the receptacle with the longest dimension (L) aligned in a substantially horizontal direction; and
a housing surrounding the receptacle when located in the seat and comprising a lid above the seat and allowing loading of the receptacle onto the seat.

Having the receptacle located with its longest dimension aligned in a substantially horizontal direction has the advantage that the overall height of the apparatus above a surface on which it is located can be minimised. Such an advantage is especially important for domestic devices wherein users often place them on kitchen counter-tops that are able to accommodate devices of limited height owing to their location directly below kitchen storage cabinets and the like. It is important in the present invention that the lid (which acts as a door through which the receptacle is loaded into the device) is above the seat as this allows for the front of the device to contain mechanisms and/or electronics for the user's convenience. If the door for loading the receptacle were at the front of the device, this would risk damage or over complication of such mechanisms and electronics.

By the term “longest dimension” used herein is meant the one of the height, width and depth of the receptacle which is the greatest. Preferably the longest dimension (L) is an axis extending from a first end of the receptacle comprising the compressed gas inlet to a second end of the receptacle comprising the product outlet.

By “aligned in a substantially horizontal direction” is meant aligned within 30 degrees of horizontal, more preferably at least 20 degrees, more preferably still at least 10 degrees and most preferably within 5 degrees.

A potential drawback of a device comprising a lid is that although the height of the device may be minimized in a closed configuration, when in an open configuration the lid may increase the overall height. Thus it is preferred that the lid is openable by sliding and/or pivoting at least partially in a horizontal direction. More preferably, the lid is pivotabley attached to a body of the housing and most preferably the lid is attached to the body through a 4 bar linkage mechanism.

The features of the present device are especially advantageous when high pressure (for example at least 0.5 bar, more preferably between 1 and 5 bar) is required to dispense the frozen confection. Such high pressures are generally required where the frozen confection is highly viscous or pasty.

Frozen confection means a confection made by freezing a mix (preferably a pasteurized mix) of ingredients such as water, fat, sweetener, protein (normally milk proteins), and optionally other ingredients such as emulsifiers, stabilisers, colours and flavours. Frozen confection materials may be aerated. Frozen confection materials include ice cream, gelato, frozen yoghurt, sorbets, granitas, shaved ices and the like. Preferably the frozen confection is ice cream.

The frozen confection may be aerated. The term “aerated” means that gas has been intentionally incorporated into the product, such as by mechanical means. The gas can be any food-grade gas such as air, nitrogen or carbon dioxide. The extent of aeration is typically defined in terms of “overrun” (OR). In the context of the present invention, % overrun is defined in volume terms (measured at atmospheric pressure) as:

$$O R = \frac{\begin{matrix}volume of frozen aerated product - \\ volume of premix at ambient temp\end{matrix}}{volume of premix at ambient temp} \times 100$$

The amount of overrun present in the aerated frozen confection will vary depending on the desired product characteristics. In the context of the present invention the level of overrun is typically from 0 to 150%, more preferably from 60 to 150%, most preferably from 60 to 100%.

In a preferred embodiment the device is self-contained and does not rely on external sources of pressure. Preferably the device comprises:
a compressed gas source; and
a gas conduit extending from the compressed gas source to a compressed gas outlet.

Having the device self-contained allows any high pressure equipment to be safely contained within the housing. As an extra safety feature it is preferred that the device comprises a control system configured to restrict or prevent activation of the gas source when the lid is not closed.

The device preferably comprises:
a mechanism for adjusting the relative position of the receptacle and compressed gas outlet in response to movement of the lid to urge the compressed gas outlet and the compressed gas inlet into sealing engagement as the lid is closed.

Linking the movement of the lid to the sealing engagement of the gas outlet and the inlet on the receptacle dispenses with the requirement for a user to manually seal the two together and so allows for devices that are more convenient to use, especially where users need not be trained to make a manual seal. Also, linking the sealing to the movement of the lid provides an extra safety feature without the need for complex pressure-relief valves: With the lid in an open position, the receptacle is not under pressure even if the gas source is still active

In one embodiment the mechanism converts arcuate movement of the lid into linear translation of the outlet, the inlet or both, most preferably the outlet or both. Thus as the lid is swung closed its movement is transmitted (through, for example, a cam mechanism and/or one or more transmission members) to bring the outlet and inlet together. Preferably the transmission member(s) comprise one or more transmission rods.

The use of gas pressure to dispense food compositions is most effectively and hygienically achieved if the gas pressure does not act directly on the food composition but rather through a moveable wall (such as piston, bag or membrane). Thus, the receptacle comprises at least the two compartments separated by an at least partially moveable wall.

The moveable wall is such that a dispensing force can be transmitted from the compressed gas through the wall to the frozen confection. Examples of such receptacles include bag-in-bottles (where the bag acts as the moveable wall) and cartridges containing pistons (where the piston acts as the moveable wall) although other configurations are possible including, for example, containers with an end wall that is deformable to become the moveable wall (as described, for example in U.S. Pat. No. 5,893,485). Examples of bag-in-bottle type receptacles are described in WO 2007/039158 A and examples of piston-in-cartridge type receptacles are described in EP 1 449 441 A both of which documents are hereby incorporated by reference in their entirety. Most preferred are bag-in-bottle type receptacles.

The utility of the present invention is especially enhanced where the receptacle is replaceable. Therefore it is preferred that the receptacle is disposable or recyclable.

The receptacle preferably contains multiple portions of frozen confection, more preferably wherein the receptacle contains at least 200 g of frozen confection, even more preferably between 250 and 3000 g, more preferably still between 300 and 2000 g and most preferably between 400 and 1000 g.

In a second aspect, the present invention provides a system comprising the device of any embodiment of the first aspect and one or more of the receptacles.

In a third aspect, the present invention is directed to a method for dispensing a frozen confection from a receptacle comprising the steps of:
locating the receptacle on the seat of the device according to any embodiment of the first aspect with the longest dimension (L) of the receptacle aligned in a substantially horizontal direction;
closing the lid; and
introducing compressed gas through the inlet and into the second compartment to cause the moveable wall to apply pressure on the frozen confection in the first compartment.

Where the device comprises the mechanism for adjusting the relative position of the receptacle and compressed gas outlet in response to movement of the lid to urge the compressed gas outlet and the compressed gas inlet into sealing engagement as the lid is closed, it is preferred that the step of the method of closing the lid of the device urges the compressed gas outlet and the compressed gas inlet into sealing engagement.

Where the receptacle contains multiple portions of frozen confection, the receptacle will typically be stored in a freezer between dispensing occasions as this removes or at least reduces the need for the device to have its own refrigeration means and/or for the housing to be insulated. Thus in a preferred embodiment of the method, the receptacle is stored at a temperature of less than −7° C., preferably less than −10° C., most preferably at a temperature of from −15 to −25° C. in a separate storage freezer between uses.

### DETAILED DESCRIPTION OF PREFERRED EMBODIMENTS

The present invention will now be described, by way of example only, with reference to the figures, wherein:

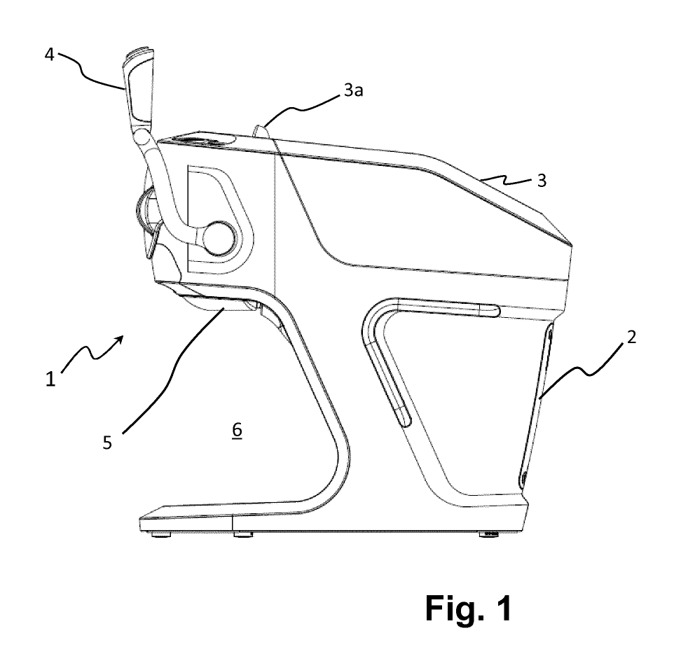

FIG. 1 shows a side view of the outside of a device according to an embodiment of the invention and which dispenses frozen confection from bag-in-bottle type receptacles.

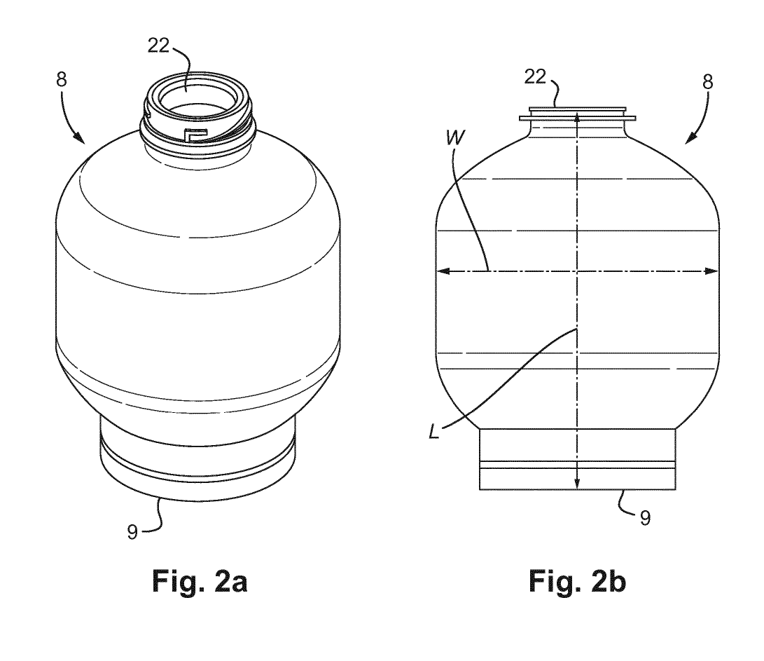

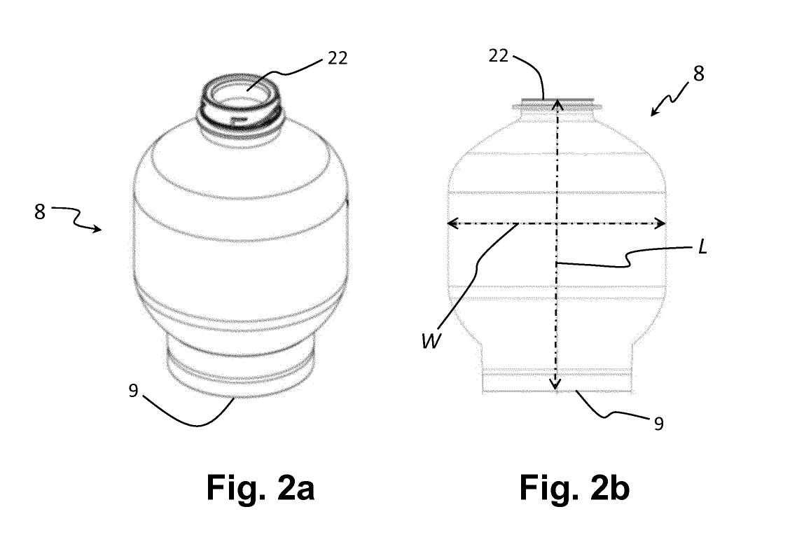

FIG. 2 shows a receptacle suitable for use in the device of FIG. 1 in (a) perspective view and (b) a side projection.

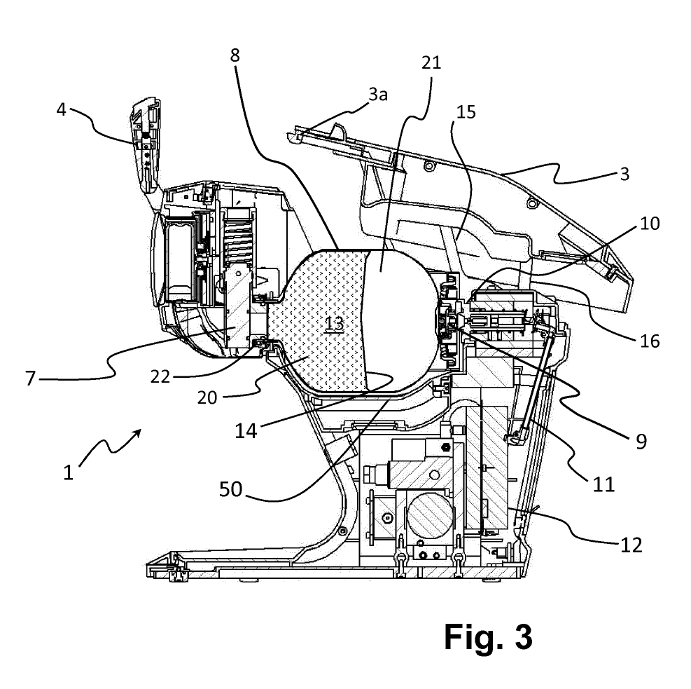

FIG. 3 shows a sectional view of the device of FIG. 1 with its lid open and a receptacle in place for dispensing.

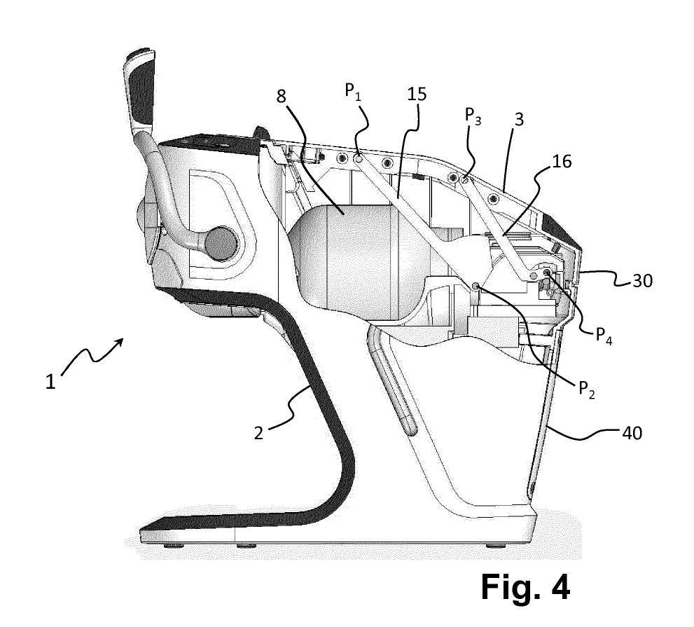

FIG. 4 shows a side view of the device of FIG. 1 partially cut away to show the lid opening mechanism and with the lid in closed position.

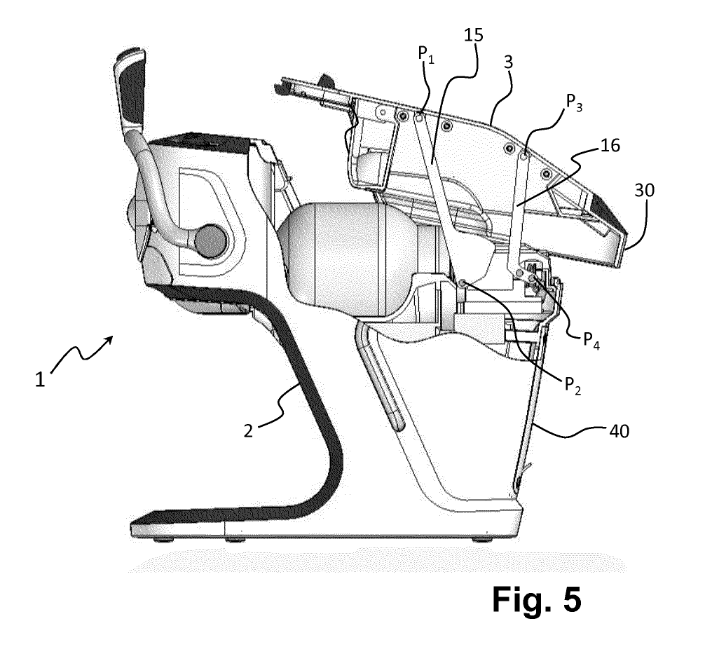

FIG. 5 is similar to FIG. 4 except that the lid is in open position.

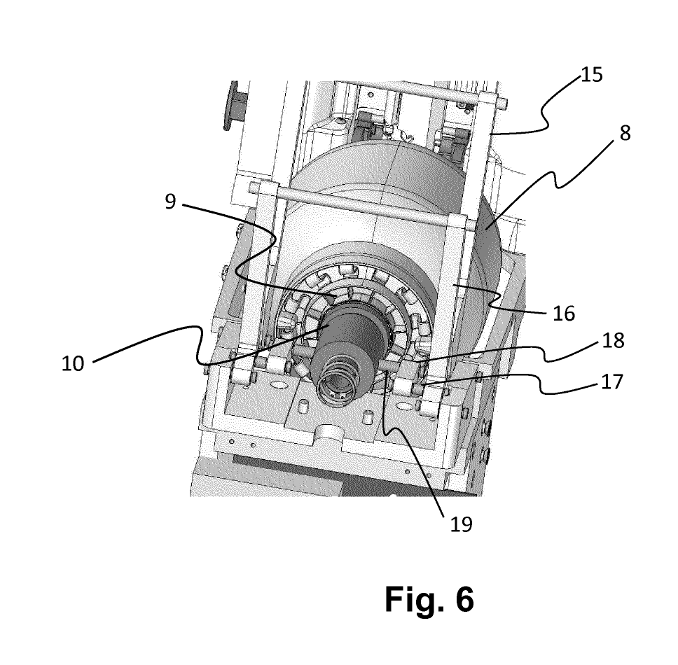

FIG. 6 shows detail of part of the inside of the device of FIG. 1.

The embodiment of the device and receptacle shown in FIGS. 1 to 6 is suitable for dispensing frozen confections from bag-in-bottle type receptacles. The device (1) comprises a housing (2) and a lid (3) which together enclose the receptacle (8). The lid (3) is connected to the housing (2) through two pairs of leg struts (15,16) to provide a 4 bar linkage mechanism about which the lid (3) can be moved in and out of closure with the housing (2) and which will be described in further detail below.

The outside of the bottle of the receptacle (8) is shown in detail in FIG. 2. The bottle has generally cylindrical form but narrows at a first end to a generally cylindrical gas inlet (9) and at a second end to a generally cylindrical product outlet (22). The distance between the two ends is greater than the widest diameter (W) of the receptacle and so in this case the axis passing longitudinally through the gas inlet (9) and product outlet (22) is the longest dimension (L).

Further detail of the receptacle (8) in place in the device (1) can be seen in FIG. 3. The bag (14) inside the bottle of the receptacle (8) forms a compartment (20) containing the frozen confection (13). The compartment containing the frozen confection (13) is open at the product outlet (22) which is also the neck of the bottle of the receptacle (8) and which receives the inlet of a dispensing valve (7). The bottle of the receptacle (8) also comprises an inlet (9) through which compressed gas can be introduced through an orifice thereof to a propellant compartment (21) inside of the bottle of the receptacle (8) but outside of the bag (14).

The receptacle (8) rests on a seat (50) with the longest dimension (L) aligned horizontally.

The device (1) comprises a gas outlet (10) which with the lid (3) in an open position is aligned with but spaced away from the inlet (9) of the receptacle (8). The gas outlet (10) is connected to an air pump (12) through an air line (11), forming in this embodiment the compressed gas source and conduit respectively.

As best seen in FIG. 6, the gas outlet (10) is connected through transmission rods (18) and link pins (17, 19) to one of the pairs (16) of leg struts which link the housing (2) to the lid (3).

FIGS. 4 and 5 show further details of the opening mechanism of the lid.

In the closed position shown in FIG. 4, the rear (30) of the lid (3) is generally aligned with the rear (40) of the housing (2). The front pair of leg struts (15) are connected to the lid (3) via one or more pins at a first pivot line (P₁) and to the housing (2) via one or more pins at a second pivot line (P₂). The rear pair of leg struts (16) are connected to the lid (3) via one or more pins at a third pivot line (P₃) and to the housing (2) via one or more pins at a second pivot line (P₄). Owing to this 4-bar linkage mechanism the lid is not only displaced upwards during opening but also has some horizontal movement such that the rear (30) of the lid (3) moves backwards of the rear (40) of the housing (2) as shown in FIG. 5. This horizontal movement allows easy access to the receptacle without increasing the overall height of the device to a great extent.

In use a receptacle (8) filled with ice cream or another frozen confection (13) is taken from a storage freezer and installed in the device (1) through the lid (3). The lid (3) is then swung closed about the 4 bar linkage formed by the struts (15, 16). As the rear struts (16) pivot forward, they move the transmission rods (18) with them which causes the gas outlet (10) to slide towards the gas inlet (9) of the receptacle (8). As the lid (3) reaches its closed position, the movement of the gas outlet (10) is completed and it encloses in an air-tight manner, the orifice of the gas inlet (9) of the receptacle. In the closed position the lid locks to the housing (2) via a latch (3a).

The housing (2) also comprises a micro-switch (not shown) which is activated only when the latch (3a) of the lid (3) is in the closed position. Activation of the micro-switch causes the air pump to be activated and begin feeding air through the air line (11), the outlet (10) and the inlet (9) into the region (21) of the receptacle (8) between the outer bottle and the bag (14). Air is pumped until the desired pressure (for example about 2 bar) is achieved.

The user then actuates the valve (7) by pulling a handle (4) to which it is connected. The frozen confection (13) is then urged through the open valve (7) by the air pressure acting on the bag (14). The dispensed ice cream flows through a dispensing opening (5) below the valve (7) to a space (6) which can accommodate a bowl, cone or other receptacle. If a large amount of ice cream is dispensed then the air pump (12) may periodically activate to keep the pressure within the receptacle (8) above a set threshold and thus prevent the flow rate of the ice cream becoming too slow.

Once the desired amount of ice cream has been dispensed, the user returns the handle (4) to its original position which in turn closes the valve (7). The user then actuates the latch (3a) which causes the pump to deactivate and pressure inside the device and receptacle to be dumped. As the lid (3) is opened, the rear struts (16) pivot backwards, moving the transmission rods (18) with them which causes the gas outlet (10) to slide away from the gas inlet (9) of the receptacle (8). The user then removes the receptacle (8) from the device (1) and places it back in the storage freezer until the next dispensing occasion or, if it is empty, send it for recycling.

The micro-switch which is activated by the latch (3a) provides that the receptacle (8) can only be pressurized when the lid (3) is closed. Furthermore if this safety feature were to fail then the feature that the gas inlet (10) is decoupled from the receptacle (8) when the lid (3) is opened ensures that the user cannot handle the receptacle (8) in a pressurized state.

All numbers in this description indicating amounts of material, time periods, length scales, conditions of reaction, physical properties of materials and/or use may optionally be understood as modified by the word “about”.

It should be noted that in specifying any range of values, any particular upper value can be associated with any particular lower value.

For the avoidance of doubt, the word “comprising” is intended to mean “including” but not necessarily “consisting of” or “composed of”. In other words, the listed steps or options need not be exhaustive.

The disclosure of the invention as found herein is to be considered to cover all embodiments as found in the claims as being multiply dependent upon each other irrespective of the fact that claims may be found without multiple dependency or redundancy.

Where a feature is disclosed with respect to a particular aspect of the invention (for example a method of the invention), such disclosure is also to be considered to apply to any other aspect of the invention (for example a device of the invention) mutatis mutandis.

1. A device for dispensing a frozen confection from a receptacle having a longest dimension (L) and comprising:
a first compartment containing the frozen confection and having a product outlet; and
a second compartment comprising a compressed gas inlet and separated from the first compartment by an at least partially moveable wall;
wherein the device comprises:
a seat for locating the receptacle with the longest dimension (L) aligned within 30 degrees of horizontal; and
a housing surrounding the receptacle when located in the seat and comprising a lid above the seat and allowing loading of the receptacle onto the seat.

2. The device as claimed in claim 1 wherein the longest dimension (L) is an axis extending from a first end of the receptacle comprising the compressed gas inlet to a second end of the receptacle comprising the product outlet.

3. The device as claimed in claim 1 wherein the lid is openable by sliding and/or pivoting at least partially in a horizontal direction.

4. The device as claimed in claim 3 wherein the lid is pivotably attached to a body of the housing.

5. The device as claimed in claim 4 wherein the lid is attached to the body through a 4 bar linkage mechanism.

6. The device as claimed in claim 1, wherein the device comprises:
a compressed gas source; and
a gas conduit extending from the compressed gas source to a compressed gas outlet.

7. The device as claimed in claim 6 wherein the device comprises a control system configured to restrict or prevent activation of the compressed gas source when the lid is not closed.

8. The device as claimed in claim 6, wherein the device comprises a mechanism for adjusting the relative position of the receptacle and compressed gas outlet in response to movement of the lid to urge the compressed gas outlet and the compressed gas inlet into sealing engagement as the lid is closed.

9. The device as claimed in claim 8 wherein the mechanism converts arcuate movement of the lid into linear translation of the outlet, the inlet or both.

10. The device as claimed in claim 1, wherein the frozen confection is ice cream.

11. The device as claimed in claim 1 wherein the receptacle is a bag-in-bottle container wherein the moveable wall comprises the bag.

12. A system comprising the device as claimed in claim 1 and more than one of the receptacles.

13. A method for dispensing a frozen confection from a receptacle comprising the steps of:
locating the receptacle on the seat of the device as claimed in claim 1 with the longest dimension (L) of the receptacle aligned within 30 degrees of horizontal;
closing the lid; and
introducing compressed gas through the inlet and into the second compartment to cause the moveable wall to apply pressure on the frozen confection in the first compartment

14. The method as claimed in claim 13 wherein the device is as claimed in claim 8 and the step of closing the lid of the device urges the compressed gas outlet and the compressed gas inlet into sealing engagement.
